(19) United States
(12) Patent Application Publication
(10) Pub. No.: US 2023/0141121 A1
(43) Pub. Date: May 11, 2023

(54) Apparatus and Method for Reducing Fouling of Exhaust Gas Recirculation Cooler

(71) Applicants: Hyundai Motor Company, Seoul (KR); Kia Corporation, Seoul (KR)

(72) Inventor: June Hwan Jang, Yongin-si (KR)

(21) Appl. No.: 17/970,809

(22) Filed: Oct. 21, 2022

(30) Foreign Application Priority Data
Nov. 10, 2021 (KR) 10-2021-0153522

(51) Int. Cl. F02M 26/50; F02M 26/46; F02M 26/02; F02M 31/20; F01N 3/035

(52) U.S. Cl. CPC F02M 26/50; F02M 26/46; F02M 26/02; F02M 31/20; F01N 3/035

(57) ABSTRACT

An embodiment apparatus for reducing fouling of an exhaust gas recirculation (EGR) cooler includes an exhaust gas transfer part configured to connect a diesel oxidation catalyst (DOC) of an exhaust gas post-treatment system extending from an engine through an exhaust line to an EGR cooler installed in an EGR line and configured to recirculate exhaust gas discharged from an exhaust manifold to an intake manifold, a valve installed in the exhaust gas transfer part, and a controller configured to selectively open the valve as the exhaust gas post-treatment system enters a predetermined diesel particulate filter (DPF) regeneration condition and allow exhaust gas discharged from the DOC to be supplied to the EGR cooler through the exhaust gas transfer part.

### CROSS-REFERENCE TO RELATED APPLICATIONS

This application claims the benefit of Korean Patent Application No. 10-2021-0153522, filed on Nov. 10, 2021, which application is hereby incorporated herein by reference.

### TECHNICAL FIELD

The present invention relates to an apparatus and a method for reducing fouling of an exhaust gas recirculation (EGR) cooler.

### BACKGROUND

Generally, an exhaust gas of a vehicle includes harmful substances such as carbon monoxide (CO), nitrogen oxide (NOx), and hydrocarbon (HC), and NOx always has an opposite causal relationship with CO and HC among NOx, CO, and HC which are generated during combustion.

That is, NOx is maximally generated at a point in time when CO and HC are minimally reduced in a practical output range, and an amount of NOx generated increases as the fuel is completely combusted, that is, when a temperature of an engine is high.

Accordingly, since an allowable amount of exhaust gas including NOx is regulated by related laws, various technologies for reducing exhaust gas are being developed, and one of them is an exhaust gas recirculation (EGR).

In order to reduce an amount of NOx generated without a rapid increase in other harmful substances, such an EGR device is a device which is used for supplying a portion of combustion gas (EGR gas) to a mixture suctioned into a combustion chamber while maintaining a mixture ratio at a theoretical air-fuel ratio and employs a method of reducing an amount of fresh air and, simultaneously, increasing a heat capacity of the combustion gas to lower a temperature of a flame.

More specifically, the EGR device is a device for recirculating the exhaust gas to an intake system and lowering a combustion temperature in a cylinder to suppress generation of NOx and refers to a device, as a part for reducing NOx of the exhaust gas, for returning a portion of the exhaust gas to the intake system and reducing a generation amount of NOx by lowering a maximum temperature when the mixture is combusted.

In particular, as exhaust regulations have been strengthened in recent years, in order to satisfy these exhaust regulations, it is necessary to prevent additional emission of NOx according to an increase in intake air temperature due to EGR and use more EGR so that the use of an EGR cooler capable of cooling EGR gas should also be applied.

The EGR cooler is a type of a heat exchanger for cooling high-temperature exhaust gas using engine cooling water as a refrigerant. Recently, as emission regulations are strengthened, an EGR cooler with a high capacity compared with the related art is required.

In addition, when a commercial diesel engine is generally operated on a city bus route, a temperature average of gas inside an exhaust manifold of the diesel engine is 150° C., and thus gas flowing into the EGR cooler has the same level of the temperature average. However, since soot, oil, and carbides deposited inside the EGR cooler can be removed by oxidation reaction only at a temperature of 550° C. or higher, in low speed and low load operating conditions, a fouling problem in which the soot, the oil, and the carbides are deposited inside the EGR cooler inevitably occurs continuously.

### SUMMARY

The present invention relates to an apparatus and a method for reducing fouling of an exhaust gas recirculation (EGR) cooler. Particular embodiments relate to an apparatus and a method for reducing fouling of an EGR cooler, which are capable of improving a fouling phenomenon of the EGR cooler by removing soot, oil, and carbides, which are deposited in the EGR cooler, using regeneration conditions of a diesel oxidation catalyst (DOC) or a diesel particulate filter (DPF).

Embodiments of the present invention can solve problems associated with prior art.

One embodiment of the present invention provides an apparatus and a method for reducing fouling of an exhaust gas recirculation (EGR) cooler, which solve a fouling problem of soot, oil, and carbides deposited inside the EGR cooler using high temperature exhaust gas in low-speed and low-load operating conditions by selectively opening a valve at a rear end of a diesel oxidation catalyst (DOC) to allow high-temperature exhaust gas to flow into the EGR cooler in a state of controlling an EGR valve to be in a closed state, opening a three-way valve connected to the EGR cooler, allowing the high-temperature exhaust gas to pass through the EGR cooler and circulate, because a temperature of exhaust gas at the rear end of the DOC corresponds to a temperature of 550° C. or higher.

Embodiments of the present invention are not limited to the above-described embodiments, and other embodiments of the present invention, which are not mentioned, can be understood by the following description and also will be apparently understood through exemplary embodiments of the present invention. Further, the embodiments of the present invention can be implemented by means described in the appended claims and a combination thereof.

An exemplary embodiment of the present invention provides an apparatus for reducing fouling of an EGR cooler, which includes an exhaust gas transfer part configured to connect a diesel oxidation catalyst (DOC) of an exhaust gas post-treatment system extending from an engine through an exhaust line to an EGR cooler installed on an the EGR line and configured to recirculate exhaust gas discharged from an exhaust manifold to an intake manifold, a valve installed in the exhaust gas transfer part, and a controller configured to selectively open the valve as the exhaust gas post-treatment system enters a predetermined diesel particulate filter (DPF) regeneration condition and allow exhaust gas discharged from the DOC to be supplied to the EGR cooler through the exhaust gas transfer part.

Here, the apparatus may further include a three-way valve configured to allow the exhaust gas passing through the EGR cooler to move along a low pressure EGR line and allow the exhaust gas to selectively move to a turbocharger or a rear end of an intercooler, and as an EGR valve is selectively blocked due to an operating condition of the engine, the controller may open the valve and control the three-way valve to allow the exhaust gas passing through the EGR cooler to move to the turbocharger.

As the operating condition corresponds to high speed and high load conditions and thus the EGR valve is opened, the controller may block the valve and control the three-way valve to allow the exhaust gas passing through the EGR cooler to move to a rear end of the intercooler.

The apparatus for reducing fouling of an EGR cooler may further include a temperature sensor configured to measure an internal temperature of the EGR cooler, and a cooling water flow rate adjuster installed in a supply path which supplies cooling water to the EGR cooler.

Meanwhile, another exemplary embodiment of the present invention provides a method of reducing fouling of an EGR cooler, which includes a first operation of determining whether a temperature of the exhaust gas discharged from the DOC exceeds a predetermined temperature as a signal according to an entry of the DPF regeneration condition is input from an exhaust gas post-treatment system, a second operation of determining an opening degree condition of an EGR valve as a temperature of the exhaust gas exceeds the predetermined temperature in the first operation, a third operation of controlling, by a controller, the valve to be opened and allowing the exhaust gas having the temperature exceeding the predetermined temperature to be supplied to the EGR cooler through the exhaust gas transfer part when it is determined that the EGR valve is in a blocked state, a fourth operation of allowing regeneration of a supply pipe of the exhaust gas of the EGR cooler and re-determining an opening degree condition of the EGR valve as the exhaust gas is supplied to the EGR cooler, and a fifth operation of controlling, by the controller, the valve to block a supply of the exhaust gas toward the EGR cooler through the exhaust gas transfer part when it is determined that the EGR valve is in an opened state.

Here, in the second operation, when it is determined that the opening degree condition corresponding to low speed and low load conditions of the engine is satisfied through the controller when the DPF regeneration condition is entered, the EGR valve may be blocked.

In addition, in the third operation, as the exhaust gas is supplied to the EGR cooler through the exhaust gas transfer part, a three-way valve may be controlled so that the exhaust gas passing through the EGR cooler may move to a turbocharger along a low pressure EGR line.

In addition, in the fourth operation, when it is determined that the opening degree condition corresponding to high speed and high load conditions of the engine is satisfied through the controller, the EGR valve may be opened.

In addition, in the fifth operation, as a supply of the exhaust gas toward the EGR cooler through the exhaust gas transfer part is blocked, the three-way valve may be controlled to allow the exhaust gas passing through the EGR cooler to move to a rear end of an intercooler along a lower pressure EGR line.

### BRIEF DESCRIPTION OF THE DRAWINGS

The above and other features of embodiments of the present invention will now be described in detail with reference to certain exemplary embodiments thereof illustrated in the accompanying drawings which are given hereinbelow by way of illustration only, and thus are not limitative of the present invention, and wherein:

FIG. 1 is a diagram illustrating a configuration of an apparatus for reducing fouling of an exhaust gas recirculation (EGR) cooler according to one embodiment of the present invention;

FIG. 2 is a diagram illustrating a temperature of exhaust gas at a rear end of a diesel oxidation catalyst (DOC) in the apparatus for reducing fouling of an EGR cooler according to one embodiment of the present invention; and

FIG. 3 is a diagram sequentially illustrating a method of reducing fouling of an EGR cooler according to another embodiment of the present invention.

It should be understood that the appended drawings are not necessarily to scale, presenting a somewhat simplified representation of various preferred features illustrative of the basic principles of embodiments of the present invention. The specific design features of embodiments of the present invention as disclosed herein, including, for example, specific dimensions, orientations, locations, and shapes will be determined in part by the particular intended application and use environment.

In the figures, reference numbers refer to the same or equivalent parts of embodiments of the present invention throughout the several figures of the drawings.

### DETAILED DESCRIPTION OF ILLUSTRATIVE EMBODIMENTS

Hereinafter, exemplary embodiments according to the present invention will be described in detail with reference to the accompanying drawings.

The advantages and features of embodiments of the present invention and the manner of achieving the advantages and features will become apparent with reference to the embodiments described in detail below with the accompanying drawings.

The present invention may, however, be implemented in many different forms and should not be construed as being limited to the embodiments set forth herein, and the embodiments are provided such that this disclosure will be thorough and complete and will fully convey the scope of the present invention to those skilled in the art to which the present invention pertains, and the present invention is defined by only the scope of the appended claims.

Further, in the following description of embodiments of the present invention, when a detailed description of a known related art is determined to unnecessarily obscure the gist of the present invention, the detailed description thereof will be omitted herein.

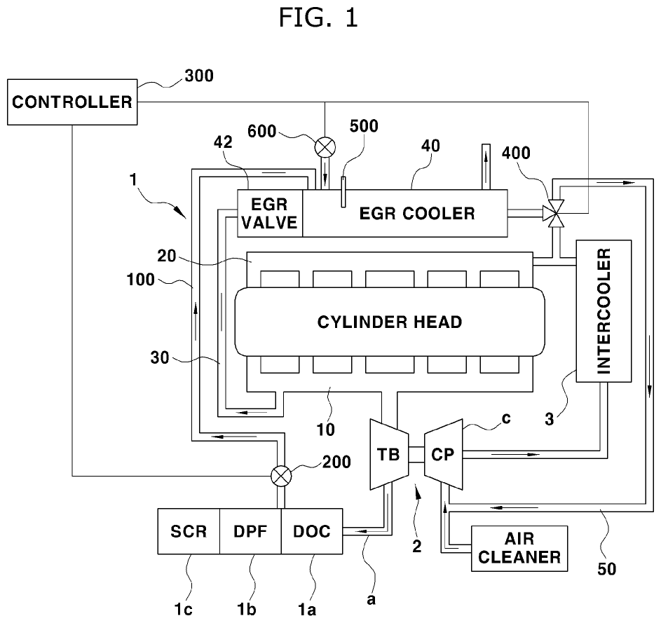

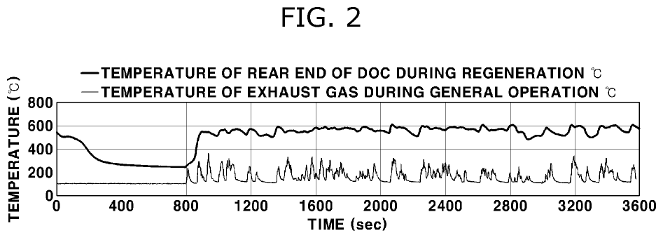

FIG. 1 is a diagram illustrating a configuration of an apparatus for reducing fouling of an exhaust gas recirculation (EGR) cooler according to one embodiment of the present invention, and FIG. 2 is a diagram illustrating a temperature of exhaust gas at a rear end of a diesel oxidation catalyst (DOC) in the apparatus for reducing fouling of an EGR cooler according to one embodiment of the present invention.

Referring to FIG. 1, the apparatus for reducing fouling of an EGR cooler according to the present embodiment includes an exhaust gas transfer part 100, a valve 200, and a controller 300.

First, the exhaust gas transfer part 100 is provided to connect a rear end of a diesel oxidation catalyst (DOC) is of an exhaust gas post-treatment system 1 extending from an engine through an exhaust line a to an EGR cooler 40 installed in an EGR line 30 and configured to recirculate exhaust gas discharged from an exhaust manifold 10 to an intake manifold 20.

Generally, the exhaust gas post-treatment system 1 is sequentially disposed along a flow of the exhaust gas. For example, the DOC 1a, a diesel particulate filter (DPF) 1b, and a selective catalytic reduction (SCR) 1c are sequentially disposed, and thus the exhaust gas discharged from the engine sequentially passes through the DOC 1a, the DPF 1b, and the SCR 1c, harmful substances are purified or removed, and then the exhaust gas is discharged to the atmosphere.

That is, the DOC 1a has a function of oxidizing and removing hydrocarbon HC and carbon monoxide CO in the exhaust gas and a function of oxidizing nitrogen monoxide NO in the exhaust gas to generate nitrogen dioxide NO₂. The DPF 1b is a particular matter (PM) collecting device using a filter and is a device which is installed on the exhaust line a of the engine and collects PM such as soot discharged from the engine by the filter and removes the PM from the exhaust gas. The SCR 1c is disposed to remove nitrogen oxide (NOx) from the exhaust gas.

Here, in removal of the PM such as soot through the DPF 1b, in order to allow soot to be removed even in low speed and low load operating conditions, a temperature of a rear end of the DOC 1a becomes relatively high so that the exhaust gas having a temperature close to a range from 550° C. to 600° C. may be generated.

In other words, since the DOC 1a is located relatively upstream when compared with the DPF 1b and the SCR 1c, activation may be performed in a relatively short period of time, and thus when a temperature of the DOC 1a rises, the exhaust gas having a temperature close to a range from 550° C. to 600° C. may be generated at the rear end of the DOC 1a.

To describe in more detail, for example, in the case of a commercial engine mounted on a city bus, as shown in FIG. 2, a temperature of an internal gas of the exhaust manifold 10 has an average level of 150° C., and gas flowing into the EGR cooler 40 also has the same level. However, soot, oil, and carbide, which are deposited inside the EGR cooler 40, may be removed only by oxidation reaction at a temperature of 550° C. or higher.

Thus, in the low speed and low load operating conditions of the engine, even when the exhaust gas at a temperature level of 150° C. moves along the EGR line 30 from the exhaust manifold 10, the temperature of the exhaust gas does not reach a temperature for removing the soot, the oil, and the carbide by the oxidation reaction, and thus a fouling problem due to relative accumulation of the soot, the oil, and the carbide in a supply pipe of the exhaust gas of the EGR cooler 40 is inevitably continuously generated.

Accordingly, as described above, when the temperature of the DOC 1a rises, since the exhaust gas having a temperature close to a range from 550° C. to 600° C. may be generated at the rear end of the DOC 1a (see FIG. 2), it is possible to solve the fouling problem in the EGR cooler 40 using the exhaust gas even in the low speed and low load driving conditions of the engine.

To this end, as shown in FIG. 1, the valve 200 is installed in the exhaust gas transfer part 100 to allow the exhaust gas generated at the rear end of the DOC 1a to move to the EGR cooler 40 through selective opening and closing.

When the exhaust gas post-treatment system 1 is set to a DPF regeneration condition, for example, when NOx purification efficiency is lowered, in order to remove the soot deposited inside the DPF 1b, the controller 300 introduces fuel into a front end of the DOC 1a through post and HCI injections. Consequently, as an exothermic reaction occurs inside the DOC 1a, the exhaust gas moved through the exhaust line a is heated to a high temperature. In this case, the exhaust gas in a heated state is allowed to move to the EGR cooler 40 along the exhaust gas transfer part 100 through opening control of the valve 200.

Eventually, in the opening control of the valve 200, only when the temperature of the rear end of the DOC 1a is 550° C. or higher, the controller 300 selectively controls to open the valve 200 and, as a result, the exhaust gas of a high temperature is supplied so that soot accumulated in the supply pipe of the exhaust gas of the EGR cooler 40 is removed.

Here, in order to remove the soot deposited in the DPF 1b, when the post and HCI injections are performed in the low speed and low load operating conditions of the engine, the controller 300 controls to block an EGR valve 42 to prevent fouling caused by the fuel, which is introduced due to the post injection, and oil moving to intake throttling.

Meanwhile, the apparatus for reducing fouling of an EGR cooler according to the present embodiment further includes a three-way valve 400, and the three-way valve 400 allows the exhaust gas passing through the EGR cooler 40 to move along a low pressure EGR line 50 and to selectively move to a turbocharger 2 or a rear end of an intercooler 3.

As described above, as the post and HCI injections are performed in the low speed and low load operating condition of the engine and thus the EGR valve 42 is blocked, the controller 300 opens the valve 200 and controls an opening direction of the three-way valve 400 to allow the exhaust gas passing through the EGR cooler 40 to move to a compressor C of the turbocharger 2.

This is because, since the exhaust gas passing through the EGR cooler 40 maintains a relatively high temperature, the exhaust gas passes through the intercooler 3 along the low-pressure EGR line 50, which is formed to be relatively long and has improved distribution per cylinder due to mixing of outside air before the exhaust gas is introduced, and flows into a combustion chamber of the engine.

In addition, when the EGR valve 42 is opened as the low speed and low load operating conditions of the engine are switched to high speed and high load operating conditions of the engine, the controller 300 blocks the valve 200 and controls the three-way valve 400 to allow the exhaust gas passing through the EGR cooler 40 to move to the rear end of the intercooler 3.

In other words, since the temperature of the exhaust gas is 550° C. or higher in the high speed and high load operating conditions, even without supplying the exhaust gas of a high temperature discharged from the DOC 1a to the EGR cooler 40 through the exhaust gas transfer part 100, when the EGR valve 42 is opened, a fouling problem caused by soot accumulation in the exhaust gas supply pipe in the EGR cooler 40 may be solved only using the exhaust gas of a high temperature circulating through the EGR line 30.

As described above, in a blocking control state of the valve 200 through the controller 300, the opening direction of the three-way valve 400 is controlled to be connected to the rear end of the intercooler 3 so that circulation of the exhaust gas is achieved as in a general operation of the engine.

In addition to the above description, the apparatus for reducing fouling of an EGR cooler according to the present embodiment may further include a temperature sensor 500 and a cooling water flow rate adjuster 600. The temperature sensor 500 is provided to measure an internal temperature of the EGR cooler 40, and the cooling water flow rate adjuster 600 is installed in a supply path for supplying cooling water to the EGR cooler 40 and may include a valve for adjusting a flow rate of the supplied cooling water.

Accordingly, in order to remove the soot deposited in the EGR cooler 40 through the opening and closing control of the valve 200 to increase cooling efficiency, when a DFP regeneration condition is terminated and then the controller 300 enters the DFP regeneration condition again, and when a temperature of the EGR cooler 40 rises relatively slowly during a supply of the exhaust gas of a high temperature discharged from the rear end of the DOC 1a, the controller 300 may control the cooling water flow rate adjuster 600, specifically, may reduce an opening amount to raise a temperature of the cooling water of the EGR cooler 40 to a level of a temperature of 120° C., which corresponds to a temperature of the boiling point of antifreeze, thereby increasing cooling efficiency of the EGR cooler 40.

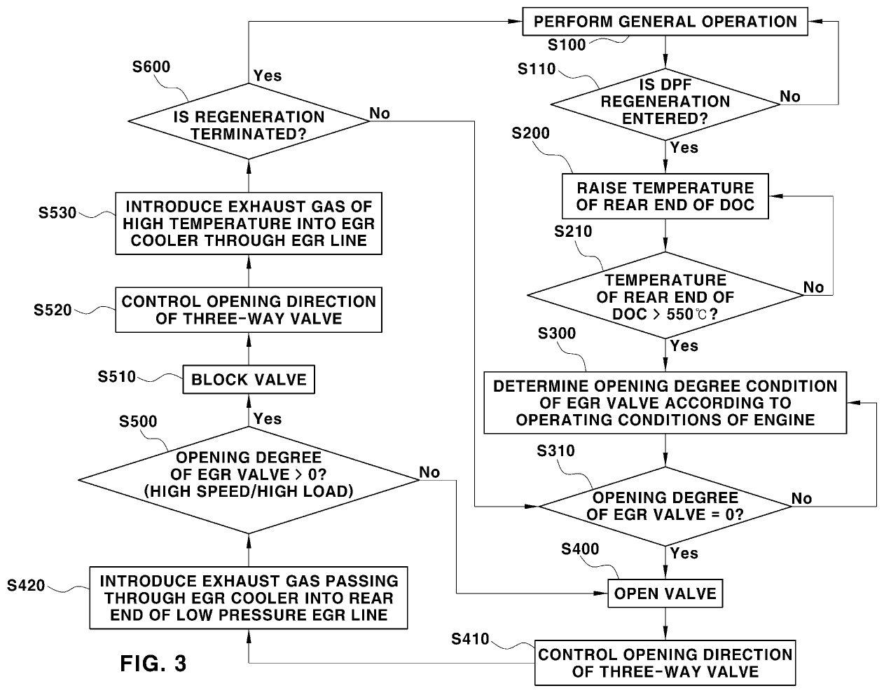

FIG. 3 is a diagram sequentially illustrating a method of reducing fouling of an EGR cooler according to another embodiment of the present invention.

As shown in FIG. 3, the method of reducing fouling of an EGR cooler according to the present embodiment will be sequentially described as follows.

First, among general operating conditions (S100), whether a predetermined DPF regeneration condition is entered, that is, for example, when it is determined that purification efficiency of NOx is degraded (S110), in order to remove soot deposited inside the DPF 1b, fuel is introduced into the front end of the DOC 1a through post and HCI injections. Consequently, an exothermic reaction occurs inside the DOC 1a, and the exhaust gas moved through the exhaust line a is heated to a high temperature (S200).

Generally, in removal of PM such as soot through the DPF 1b, in order to allow soot to be moved even in low speed and low load operating conditions, a temperature of a rear end of the DOC 1a becomes relatively high so that the exhaust gas having a temperature close to a range from 550° C. to 600° C. may be generated.

In other words, since the DOC 1a is located relatively upstream when compared with the DPF 1b and the SCR 1c, activation may be performed in a relatively short period of time, and thus when a temperature of the DOC 1a rises, the exhaust gas of a high temperature may be generated at the rear end of the DOC 1a.

Therefore, as described above, when the exhaust gas moving through exhaust line a is heated to a high temperature (S200), it is determined whether the temperature is a temperature of 550° C. or higher (S210). When it is determined that the temperature rises to the temperature of 550° C. or higher, an opening degree condition of the EGR valve 42 according to the operating conditions of the engine is determined (S300).

That is, in order to remove soot deposited in the DPF 1b, when post and HCI injections are performed in low speed and low load operating conditions of the engine, the EGR valve 42 is blocked to prevent fouling caused by the fuel, which is introduced due to the post injection, and oil moving to intake throttling (S310). As described above, in a state in which a temperature condition of the rear end of the DOC 1a is satisfied, when the EGR valve 42 is blocked, the controller 300 controls an opening of the valve 200 (S400) to allow the exhaust gas of a high temperature to flow to a supply pipe of the exhaust gas of the EGR cooler 40 along the exhaust gas transfer part 100 (S410).

For example, in the case of a commercial engine mounted on a city bus, a temperature of an internal gas of the exhaust manifold 10 has an average level of 150° C. (see FIG. 2), and gas flowing into the EGR cooler 40 also has the same level. However, soot, oil, and carbide, which are deposited inside the EGR cooler 40, may be removed only by oxidation reaction at a temperature of 550° C. or higher.

Thus, in the low speed and low load operating conditions of the engine, even when the exhaust gas at a temperature level of 150° C. moves along the EGR line 30 from the exhaust manifold 10, the temperature of the exhaust gas does not reach a temperature for removing the soot, the oil, and the carbide by the oxidation reaction, and thus a fouling problem due to relative accumulation of the soot, the oil, and the carbide in a supply pipe of the exhaust gas of the EGR cooler 40 is inevitably continuously generated.

Accordingly, when the temperature of the DOC 1a rises, since the exhaust gas having a temperature close to a range from 550° C. to 600° C. may be generated at the rear end of the DOC 1a (see FIG. 2), it is possible to solve the fouling problem in the EGR cooler 40 using the exhaust gas even in the low speed and low load driving conditions of the engine.

As described above, when the opening control of the valve 200 is performed through the controller 300 (S400), in this case, the controller 300 controls an opening direction of the three-way valve 400 to allow the exhaust gas passing through the EGR cooler 40 to move along the low pressure EGR line 50 and to selectively move to the compressor C of the turbocharger 2 (S410).

This is because, since the exhaust gas passing through the EGR cooler 40 maintains a relatively high temperature, the exhaust gas passes through the intercooler 3 along the low-pressure EGR line 50, which is formed to be relatively long and has improved distribution per cylinder due to mixing of outside air before the exhaust gas is introduced, and flows into a combustion chamber of the engine (S420).

During the above process, when the operating condition of the engine is switched from the low speed and low load operating conditions to the high speed and high load operating conditions, it is determined whether the EGR valve 42 is opened (S500). When it is determined that the EGR valve 42 is opened, the controller 300 blocks the valve 200 (S510) and controls the opening direction of the three-way valve 400 to allow the exhaust gas passing through the EGR cooler 40 to move to a rear end of the intercooler 3 (S520).

Thus, the exhaust gas moves from the rear end of the intercooler 3 to the intake manifold 20 and, like during the general engine operation, the exhaust gas circulates along the EGR line 30 which is a normal path (S530). In this case, since the temperature of the exhaust gas is 550° C. or higher in the high speed and high load conditions, the fouling problem inside the EGR cooler 40 no longer occurs due to the circulation of the exhaust gas at that temperature, so it is determined that whether regeneration of the soot for the EGR cooler 40 is terminated (S600).

Here, as a result of the determination of whether the regeneration of the soot for the EGR cooler 40 is terminated (Yes at S600), when it is determined that the regeneration is terminated, during the general operating conditions (S100), determining whether to enter the predetermined DPF regeneration condition (S110) is performed again continuously. In this case, when it is determined that the regeneration is not terminated (No at S600), in a state in which the EGR valve 42 is blocked, control is repeatedly performed until a time when the entry into the DPF regeneration condition is terminated and the general operation is performed (S400 to S500). Thus, it is possible to solve the fouling problem by effectively allowing soot regeneration for the supply pipe of the exhaust gas of the EGR cooler 40.

According to embodiments of the present invention, there is an effect of solving a fouling problem of soot, oil, and carbides deposited inside the EGR cooler using exhaust gas of a high temperature in low speed and low load operating conditions by selectively opening a valve at the rear end of the DOC to allow the exhaust gas of a high temperature to flow into the EGR cooler in a state of controlling an EGR valve to be in a closed state, opening a three-way valve connected to the EGR cooler, thus allowing the exhaust gas of a high temperature to pass through the EGR cooler and circulate, because a temperature of the exhaust gas at the rear end of the DOC corresponds to a temperature of 550° C. or higher.

In addition, according to embodiments of the present invention, there is an effect of measuring the temperature of the cooling water through a temperature sensor mounted in the EGR cooler to indirectly determine efficiency of the EGR cooler and, when it is determined that the internal temperature of the EGR cooler is relatively low, further increasing the efficiency of the EGR cooler by selectively adjusting the valve of the cooling water flow path to reduce the flow rate of cooling water introduced into the EGR cooler.

In accordance with embodiments of the present invention, there is an effect of solving a fouling problem of soot, oil, and carbides deposited inside an EGR cooler using exhaust gas of a high temperature in low speed and low load operating conditions by selectively opening a valve at a rear end of a DOC to allow the exhaust gas of a high temperature to flow into the EGR cooler in a state of controlling an EGR valve to be in a closed state, opening a three-way valve connected to the EGR cooler, thus allowing the exhaust gas of a high temperature to pass through the EGR cooler and circulate, because a temperature of the exhaust gas at the rear end of the DOC corresponds to a temperature of 550° C. or higher.

In addition, in accordance with embodiments of the present invention, there is an effect of measuring the temperature of the cooling water through a temperature sensor mounted in the EGR cooler to indirectly determine efficiency of the EGR cooler and, when it is determined that the internal temperature of the EGR cooler is relatively low, further increasing the efficiency of the EGR cooler by selectively adjusting the valve of the cooling water flow path to reduce the flow rate of cooling water introduced into the EGR cooler.

Although the present invention has been described with reference to the embodiments shown in the drawings, this is merely illustrative, and various modifications may be made therefrom by those skilled in the art, and it will be understood that all or a part of the above-described embodiments may be optionally combined and configured. Therefore, the true technical scope of the present invention should be defined by the technical spirit of the appended claims.

What is claimed is:

1. An apparatus for reducing fouling of an exhaust gas recirculation (EGR) cooler, the apparatus comprising:
an exhaust gas transfer part configured to connect a diesel oxidation catalyst (DOC) of an exhaust gas post-treatment system extending from an engine through an exhaust line to an EGR cooler installed in an EGR line and configured to recirculate exhaust gas discharged from an exhaust manifold to an intake manifold;
a valve installed in the exhaust gas transfer part; and
a controller configured to selectively open the valve as the exhaust gas post-treatment system enters a predetermined diesel particulate filter (DPF) regeneration condition and allow exhaust gas discharged from the DOC to be supplied to the EGR cooler through the exhaust gas transfer part.

2. The apparatus of claim 1, further comprising a three-way valve configured to allow the exhaust gas passing through the EGR cooler to move along a low pressure EGR line and to allow the exhaust gas to selectively move to a turbocharger or a rear end of an intercooler.

3. The apparatus of claim 2, wherein, as an EGR valve is selectively blocked due to an operating condition of the engine, the controller is configured to open the valve and control the three-way valve to allow the exhaust gas passing through the EGR cooler to move to the turbocharger.

4. The apparatus of claim 3, wherein, as the operating condition corresponds to high speed and high load conditions and thus the EGR valve is opened, the controller is configured to block the valve and control the three-way valve to allow the exhaust gas passing through the EGR cooler to move to the rear end of the intercooler.

5. The apparatus of claim 1, further comprising:
a temperature sensor configured to measure an internal temperature of the EGR cooler; and
a cooling water flow rate adjuster installed in a supply path that supplies cooling water to the EGR cooler.

6. A method of reducing fouling of an exhaust gas recirculation (EGR) cooler, the method comprising:
determining whether a temperature of exhaust gas discharged from a diesel oxidation catalyst (DOC) exceeds a predetermined temperature as a signal according to an entry of a diesel particulate filter (DPF) regeneration condition is input from an exhaust gas post-treatment system;
determining an opening degree condition of an EGR valve when it is determined the temperature of the exhaust gas exceeds the predetermined temperature;
controlling a valve to be opened and allowing the temperature of the exhaust gas exceeding the predetermined temperature to be supplied to the EGR cooler through an exhaust gas transfer part when it is determined that the EGR valve is in a blocked state;
allowing regeneration of a supply pipe of the exhaust gas of the EGR cooler and re-determining the opening degree condition of the EGR valve as the exhaust gas is supplied to the EGR cooler; and
controlling the valve to block a supply of the exhaust gas toward the EGR cooler through the exhaust gas transfer part when it is determined that the EGR valve is in an opened state.

7. The method of claim 6, wherein, when it is determined that the opening degree condition of the EGR valve corresponding to low speed and low load conditions of the engine is satisfied through a controller when the DPF regeneration condition is input, the EGR valve is blocked.

8. The method of claim 6, wherein, as the exhaust gas is supplied to the EGR cooler through the exhaust gas transfer part, a three-way valve is controlled so that the exhaust gas passing through the EGR cooler moves to a turbocharger along a low pressure EGR line.

9. The method of claim 6, wherein, when it is determined that the opening degree condition corresponding to high speed and high load conditions of the engine is satisfied through a controller, the EGR valve is opened.

10. The method of claim 6, wherein as a supply of the exhaust gas toward the EGR cooler through the exhaust gas transfer part is blocked, a three-way valve is controlled to allow the exhaust gas passing through the EGR cooler to move to a rear end of an intercooler along a lower pressure EGR line.

11. The method of claim 6, further comprising measuring an internal temperature of the EGR cooler.

12. An apparatus for reducing fouling of an exhaust gas recirculation (EGR) cooler, the apparatus comprising:
an exhaust gas post-treatment system comprising a diesel oxidation catalyst (DOC), a diesel particulate filter (DPF), and a selective catalytic reduction (SCR) sequentially disposed along a flow of an exhaust gas;
an exhaust gas transfer part connected to a rear end of the DOC and configured to recirculate the exhaust gas discharged from an exhaust manifold to an intake manifold;
a valve installed in the exhaust gas transfer part and configured to allow the exhaust gas generated at the rear end of the DOC to move to an EGR cooler through selective opening and closing; and
a controller configured to selectively open the valve as the exhaust gas post-treatment system enters a predetermined DPF regeneration condition and allow the exhaust gas discharged from the DOC to be supplied to the EGR cooler through the exhaust gas transfer part.

13. The apparatus of claim 12, further comprising a three-way valve configured to allow the exhaust gas passing through the EGR cooler to move along a low pressure EGR line and to allow the exhaust gas to selectively move to a turbocharger or to a rear end of an intercooler.

14. The apparatus of claim 13, wherein, as an EGR valve is selectively blocked due to an operating condition of an engine, the controller is configured to open the valve and control the three-way valve to allow the exhaust gas passing through the EGR cooler to move to the turbocharger.

15. The apparatus of claim 14, wherein, as the operating condition corresponds to high speed and high load conditions and the EGR valve is opened, the controller is configured to block the valve and control the three-way valve to allow the exhaust gas passing through the EGR cooler to move to the rear end of the intercooler.

16. The apparatus of claim 12, further comprising a temperature sensor configured to measure an internal temperature of the EGR cooler.

17. The apparatus of claim 16, further comprising a cooling water flow rate adjuster installed in a supply path that supplies cooling water to the EGR cooler.

18. The apparatus of claim 12, wherein the DOC is configured to oxidize and remove hydrocarbon and carbon monoxide in the exhaust gas and to oxidize nitrogen monoxide in the exhaust gas to generate nitrogen dioxide.

19. The apparatus of claim 18, wherein the DPF comprises a particulate matter collecting device comprising a filter and a device installed on an exhaust line of an engine, the DPF being configured to collect particulate matter discharged from the engine and remove the particulate matter from the exhaust gas.

20. The apparatus of claim 19, wherein the SCR is configured to remove nitrogen oxide from the exhaust gas.
